(19) United States
(12) Patent Application Publication
(10) Pub. No.: US 2025/0071125 A1
(43) Pub. Date: Feb. 27, 2025

(54) SYSTEMS AND METHODS FOR HARDWARE ASSISTED INITIAL AND SUBSEQUENT EVENT DETECTION

(71) Applicant: Fortinet, Inc., Sunnyvale, CA (US)

(72) Inventors: Zhi Guo, San Jose, CA (US); Xu Zhou, Sunnyvale, CA (US); Kan Xiao, San Jose, CA (US)

(73) Assignee: Fortinet, Inc., Sunnyvale, CA (US)

(21) Appl. No.: 18/238,081

(22) Filed: Aug. 25, 2023

(51) Int. Cl. H04L 9/40

(52) U.S. Cl. CPC H04L 63/1416

(57) ABSTRACT

Systems, devices, and methods are discussed for network security using hardware accelerated network traffic classification capable of classifying network traffic as a first occurrence of a network traffic event or a subsequent occurrence of a network traffic event.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2023, Fortinet, Inc.

### FIELD

Embodiments discussed generally relate to network security processes, and more particularly to systems and methods for network security using hardware accelerated network traffic classification capable of classifying network traffic as a first occurrence of a network traffic event or a subsequent occurrence of a network traffic event.

### BACKGROUND

In a denial of service (DOS) attack, a large number of requests for network access are sent over a short period of time in an attempt to overwhelm the attacked network resource(s). Mitigating such attacks can rely on determining whether a received network request is new or is a repetition of prior requests. Similarly, generating a transaction log relies upon a determination as to whether a received network request is new or is a repetition of prior requests to avoid logging repetition. To determine whether a received network request is new or is a repetition of prior requests, a typical system generates a hash table, in which each table entry includes the whole key (source IP address, destination IP address, layer four protocol, source port, destination port, etc.) used in accessing the table. Such an approach of using a hash table, however, has drawbacks. First, the hash table approach requires significant amount of memory. Second, maintaining the hash table requires significant computation costs. Third, because of the high computational cost, the hash table operations typically involve non-negligible latency.

Thus, there exists a need in the art for more advanced approaches, devices and systems for efficiently classifying network traffic.

### SUMMARY

Various embodiments provide systems and methods for network security using hardware accelerated network traffic classification capable of classifying network traffic as a first occurrence of a network traffic event or a subsequent occurrence of a network traffic event.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIGS. 1A-1C illustrate a network architecture having a network security appliance having a network event classification hardware accelerator in accordance with various embodiments;

FIGS. 2A-2B depict is a network event classification hardware accelerator in accordance with various embodiments;

FIG. 3 is a flow diagram showing a method in accordance with some embodiments for generating a search command based upon an identified network event in a network event classification hardware accelerator;

FIG. 4 is a flow diagram showing a method in accordance with some embodiments for processing network events in a network event classification hardware accelerator; and

FIG. 5 is a flow diagram showing a method in accordance with some embodiments for processing time based clearing in a network event classification hardware accelerator.

### DETAILED DESCRIPTION

Various embodiments provide systems and methods for network security using hardware accelerated network traffic classification capable of classifying network traffic as a first occurrence of a network traffic event or a subsequent occurrence of a network traffic event.

Embodiments of the present disclosure include various processes, which will be described below. The processes may be performed by hardware components or may be embodied in machine-executable instructions, which may be used to cause a general-purpose or special-purpose processor programmed with the instructions to perform portions of the processes. Alternatively, processes may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network appliance”, “network device”, or “network element” generally refers to a device or appliance in virtual or physical form that is operable to perform one or more network and/or endpoint functions. In some cases, a network appliance may be a database, a network server, computer, mobile phone, or the like. Some network elements may be implemented as general-purpose computers or servers with appropriate software operable to perform the one or more network functions. Other network elements may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance”, “network security device”, or a “network security element” that may reside within the particular network that it is protecting or network security may be provided as a service with the network security device residing in the cloud. For example, while there are differences among network security device vendors, network security devices may be classified in three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VOIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DOS attack detection and mitigation appliances).

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views or processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

Some embodiments provide methods for classifying network events into the first occurrence of the event and the subsequent occurrence of the same event. The methods include: receiving, by a network event classification circuit, a network event; generating, by the network event classification circuit, a transaction identifier identifying the network event; generating, by the network classification circuit, a search command including a subset of the transaction identifier; and executing, by the network classification circuit, the search command. Executing the search command includes: hashing the subset of the transaction identifier with a first hash seed to yield a first memory address, and hashing the subset of the transaction identifier with a second hash seed to yield a second memory address; and generating a classification of the network event based at least in part upon a first value accessed from a memory at the first memory address and a second value accessed from the memory at the second memory address.

In some instances of the aforementioned embodiments, the methods further include performing, by a processing resource, a network process using at least the classification of the network event. The network process may be, but is not limited to, a denial of service attack detection process, and/or a network transaction logging process.

In various instances of the aforementioned embodiments where the memory is organized into a plurality of tables and the subset of the transaction identifier is a first subset of the transaction identifier, the methods further include enabling, by the network classification circuit, a memory table of the plurality of tables. The memory table is selected based at least in part on a second subset of the transaction identifier.

In some instances of the aforementioned embodiments where the classification of the network event indicates an initial occurrence, the methods further include: executing, by the network classification circuit, an increment command. Executing the increment command includes incrementing the first value at the first memory address and incrementing the second value at the second memory address. In some such instances, the methods further include, when a search command corresponding to either the first memory address or the second memory address has not been received for a defined period, executing, by the network classification circuit, a decrement command. Executing the decrement command includes decrementing the first value at the first memory address and the second value at the second memory address. In some cases, the defined period is user programmable. In some such instances, the methods further include: as part of the executing the increment command, queuing, by the network classification circuit, a decrement command. A time expiration of the decrement command is determined, and based at least in part on the time expiration, executing, by the network classification circuit, the decrement command. Executing the decrement command includes decrementing the first value at the first memory address and the second value at the second memory address.

In various instances of the aforementioned embodiments, generating the classification of the network event based at least in part upon a first value accessed from a memory at the first memory address and a second value accessed from the memory at the second memory address includes: determining that both the first value and the second value are zero; and indicating that the classification of the network event indicates an initial occurrence based at least in part on the determination that both the first value and the second value are zero. In other instances of the aforementioned embodiments, generating the classification of the network event based at least in part upon a first value accessed from a memory at the first memory address and a second value accessed from the memory at the second memory address includes: determining that at least one of the first value and the second value is greater than zero; and indicating that the classification of the network event indicates a subsequent occurrence based at least in part on the determination that at least one of first value and the second value is greater than zero.

In some instances of the aforementioned embodiments, the search command is stored in a search command queue, the increment command is stored in an increment command queue, and the decrement command is stored to a decrement command queue. In some such instances, accessing a command by the network classification circuit from one of the search command queue, the increment command queue, or the decrement command is based upon a priority algorithm. In some cases, the priority algorithm causes all commands in the increment command queue to be executed before any command in either the search command queue or the decrement command queue. In various instances of the aforementioned embodiments, the network event is a network packet.

Other embodiments provide network event classification devices. The devices include: a network interface circuit configured to receive a network event, and a network processor. The network processor is configured to: generate a transaction identifier identifying the network event; generate a search command including a subset of the transaction identifier; and execute the search command. Executing the search command includes: hashing the subset of the transaction identifier with a first hash seed to yield a first memory address, and hashing the subset of the transaction identifier with a second hash seed to yield a second memory address; and generating a classification of the network event based at least in part upon a first value accessed from a memory at the first memory address and a second value accessed from the memory at the second memory address.

In some instances of the aforementioned embodiments, the device is implemented as a network interface card, and the network interface card includes a first general purpose processor configured to interface with a second general purpose processor of a network security appliance. In some such instances, the second general purpose processor is communicably coupled to a non-transitory computer readable medium having stored therein instructions which when executed by the second general purpose processor causes the second general purpose processor to perform a network process using at least the classification of the network event. The network process may be, but is not limited to, a denial of service attack detection process, and/or a network transaction logging process.

In other instances of the aforementioned embodiments, the device is imbedded into a network security appliance, and the network processor is coupled to a general purpose processor of the network security appliance. In some such instances, the general purpose processor is communicably coupled to a non-transitory computer readable medium having stored therein instructions which when executed by the general purpose processor causes the general purpose processor to perform a network process using at least the classification of the network event. The network process may be, but is not limited to, a denial of service attack detection process, and/or a network transaction logging process.

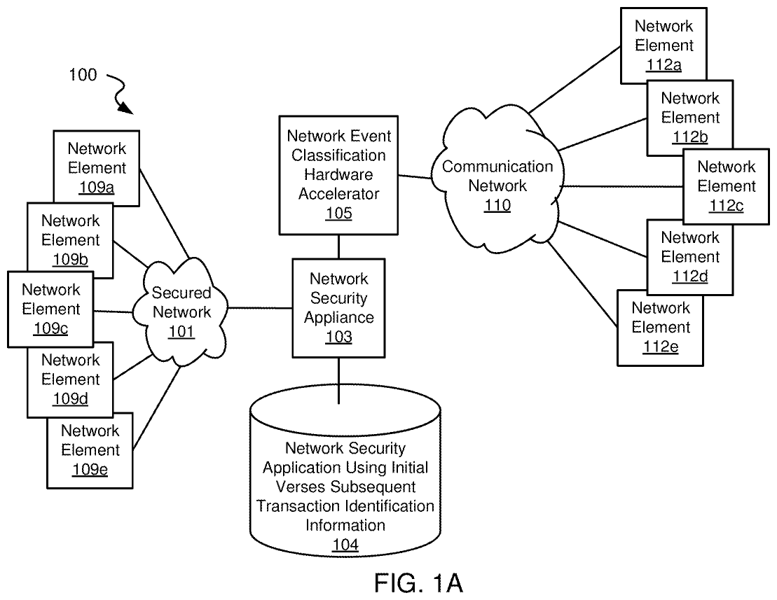

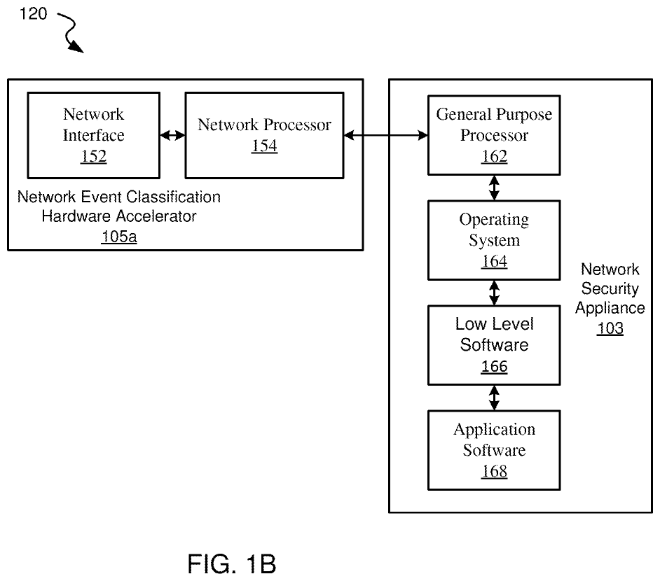

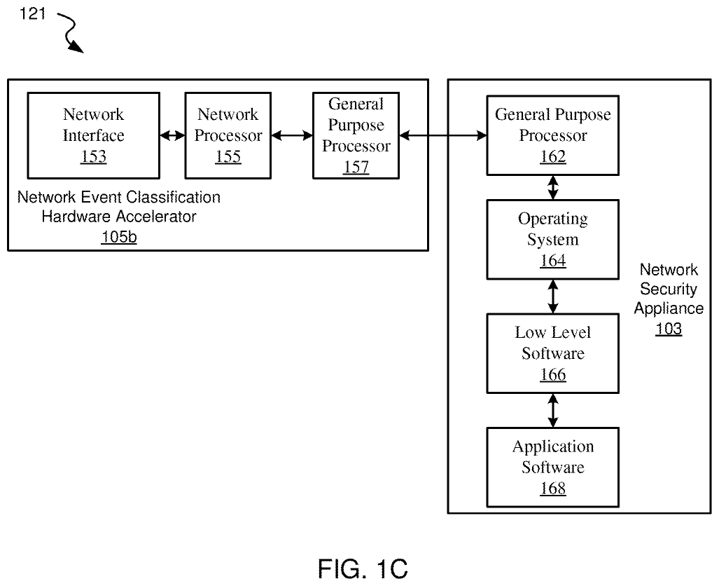

Turning to FIG. 1A, a network architecture 100 is shown in accordance with some embodiments having a network security appliance 103 augmented with a network event classification hardware accelerator 105. Network security appliance 103 protects a secured network 101. Secured network 101 may be any type of network known in the art. Thus, secured network 101 may be, but is not limited to, a wireless network, a wired network or a combination thereof that can be implemented as one of the various types of networks, such as the Internet, an Intranet, a Local Area Network (LAN), a Wide Area Network (WAN), and the like.

Secured network 101 provides for inter-network communications between network elements 109 (i.e., a network element 109a, a network element 109b, a network element 109c, a network element 109d, and/or network element 109e), and for extra-network communications between network elements 109 and other network elements outside of secured network 101 (e.g., a network element 112a, a network element 112b, a network element 112c, a network element 112d, and a network element 112e).

Network security appliance 103 operates as a gateway between secured network 101 and outside networks (e.g., a communication network 110). Communication network 110 may be any type of network known in the art. Thus, communication network 110 may be, but is not limited to, a wireless network, a wired network or a combination thereof that can be implemented as one of the various types of networks, such as the Internet, an Intranet, a Local Area Network (LAN), a Wide Area Network (WAN), and the like.

In operation, network event classification hardware accelerator 105 receives network traffic passing to/from secured network 101, and classifies the network traffic as including a first occurrence of a network traffic event or a subsequent occurrence of a network traffic event. This classification information may be used in relation to a number of processes performed by network security appliance 103. For example, in order to measure connection rate, network devices rely upon classifying the first packets of their connections and the subsequent packets. As another example, network security appliance 103 may use the classification information to provide efficient event logging where it is helpful to distinguish a first event in a log from subsequent duplicated logs. Using this information it is possible to avoid over-duplication in logs. In some embodiments, the classification information may not be as accurate as another system where a hash table, in which each table entry includes the whole key (source IP address, destination IP address, layer four protocol, source port, destination port, etc. . . . ) is used. Such embodiments, however, provide reasonable accuracy with only a fraction of the memory space and processing power. Such embodiments provide systems that provide less accurate classification information may find particular applicability to denial of service detection and log reduction where accuracy is less important than the reductions of processing power, latency, and/or system costs.

Network security appliance 103 includes a processor that executes a network security application 104 using initial verses subsequent identification information to perform one or more security processes in relation to protecting secured network 101. Network security application 104 may be, but is not limited to, a denial of service attack detection and mitigation process that relies upon the classification information provided from network event classification hardware accelerator 105. Based upon the disclosure provided herein, one of ordinary skill in the art will recognize a variety of processes that may be included in network security application in accordance with different embodiments.

Turning to FIG. 1B, a combination device 120 including network event classification hardware accelerator 105a communicably coupled to network security appliance 103 is shown in accordance with some embodiments. Network event classification hardware accelerator 105a may be used in place of network event classification hardware accelerator 105 of FIG. 1A. As shown, network event classification hardware accelerator 105a embedded into network security appliance 103 and includes a network interface circuit 152 and a network processor 154. Network processor 154 provides information directly to a general purpose processor 162 of network security appliance 103.

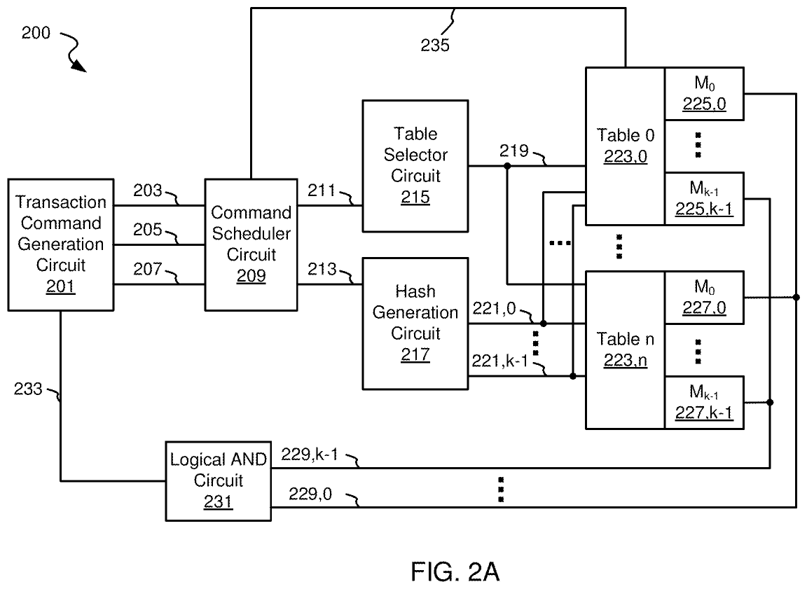

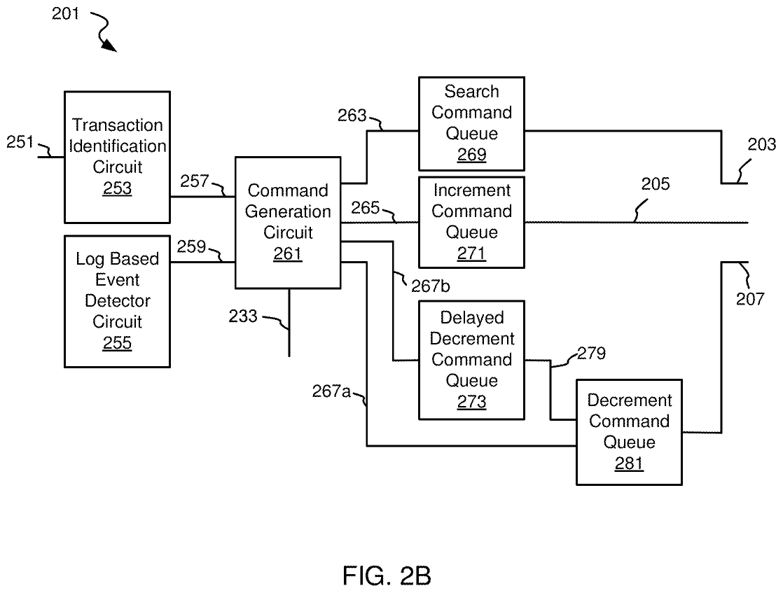

Network interface circuit 152 may be any circuit known in the art that is capable of receiving network traffic from a communication network. Network processor 154 may be, for example, an application specific processor capable of receiving network traffic from network interface circuit 152 and generating classification information for the network traffic that includes classifying received packets as either the first packets for a network session or the subsequent packets of the same network session. In some embodiments, network processor 154 may include the circuitry discussed below in relation to FIGS. 2. In some cases, some of the circuitry of FIGS. 2 is replaced with instructions executing on an embedded processor included in network processor 154.

The classification information generated by network processor 154 is provided to general purpose processor 162 included in network security appliance 103. General purpose processor 162 executes application software 168 via low level software 166 and an operating system 164. Application software 168 when executed by general purpose processor 162 causes network security appliance 103 to perform one or more processes using the classification information generated by network processor 154. Such processes may include, but are not limited to, a denial of service detection and mitigation process and/or a network transaction logging process. Based upon the disclosure provided herein, one of ordinary skill in the art will recognize a variety of processes using the classification information generated by network processor 154 that may be performed in relation to different embodiments.

Turning to FIG. 1C, a combination device 121 including network event classification hardware accelerator 105b communicably coupled to network security appliance 103 is shown in accordance with some embodiments. Network event classification hardware accelerator 105b may be used in place of network event classification hardware accelerator 105 of FIG. 1A. As shown, network event classification hardware accelerator 105b is implemented as a network interface card including a network interface circuit 152, a network processor 154, and a general purpose processor 157. Network interface circuit 152 may be any circuit known in the art that is capable of receiving network traffic from a communication network. Network processor 154 may be, for example, an application specific processor capable of receiving network traffic from network interface circuit 152 and generating classification information for the network traffic that includes classifying received packets as either the first packets for a network session or the subsequent packets of the same network session. In some embodiments, network processor 154 may include the circuitry discussed below in relation to FIGS. 2. In some cases, some of the circuitry of FIGS. 2 is replaced with instructions executing on an embedded processor included in network processor 154. General purpose processor 157 may be any general purpose processor known in the art that is capable of executing instructions for processing communications between network security appliance 103 and network event classification hardware accelerator 105b implemented as a network interface card.

The classification information generated by network processor 154 is provided to a general purpose processor 162 included in network security appliance 103. Transfer of the classification information from network processor 154 to general purpose processor 162 is facilitated by general purpose processor 157. General purpose processor 162 executes application software 168 via low level software 166 and an operating system 164. Application software 168 when executed by general purpose processor 162 causes network security appliance 103 to perform one or more processes using the classification information generated by network processor 154. Such processes may include, but are not limited to, a denial of service detection and mitigation process and/or a network transaction logging process. Based upon the disclosure provided herein, one of ordinary skill in the art will recognize a variety of processes using the classification information generated by network processor 154 that may be performed in relation to different embodiments.

Turning to FIGS. 2A-2B, a network event classification hardware accelerator 200 is shown in accordance with various embodiments. Turning to FIG. 2A, network event classification hardware accelerator 200 includes a transaction command generation circuit 201. Transaction command generation circuit 201 may be implemented as a circuit or as a processor that executes instructions causing performance of various processes, or a combination of a circuit and a processor.

Transaction command generation circuit 201 is shown in greater detail in FIG. 2B. Turning to FIG. 2B, transaction command generation circuit 201 includes a transaction identification circuit 253 that is configured to received a network traffic 251. Network traffic 251 includes network transactions that each include, for example, identifying information that may be included in a header and data to be transferred. The network transactions may or may not be encoded or encrypted. The identifying information may include, but is not limited to, a source IP address, a destination IP address, a layer four protocol, a source port, and/or a destination port. Based upon the disclosure provided herein, one of ordinary skill in the art will recognize a variety of network transactions that may be processed in accordance with different embodiments. Further, based upon the disclosure provided herein, one of ordinary skill in the art will recognize a variety of identification information that may be included in the network transaction.

Transaction identification circuit 253 generates a transaction identifier 257 using all of part of the identification information received as part of the network transaction. In some embodiments, transaction identifier 257 is a combination of two or more elements of the identification information that when combined allow for a network transaction to be identified. As more of the identification information is included in the transaction identifier, the transaction identifier becomes more likely to uniquely identify the network transaction being identified. In various embodiments, transaction identifier 257 is generated by concatenating the source IP address, the destination IP address, the source port, and the destination port. Based upon the disclosure provided herein, one of ordinary skill in the art will recognize a variety of data combinations that may be used to create transaction identifier 257 in accordance with different embodiments.

A log based event detection circuit 255 generates a transaction identifier 259 using all of part of identification information received as part of network transactions that were included in a log that is being processed. In some embodiments, transaction identifier 259 is similar to transaction identifier 257, except that it is generated from log data rather than real time network traffic 251.

A command generation circuit 261 generates search commands 263, increment commands 265, and non-timer based decrement commands 267. As part of this process, command generation circuit 261 receives a session initiation indicator 233 (from FIG. 2A) in addition to both transaction identifier 257 and transaction identifier 259. Using either of transaction identifier 257 or transaction identifier 259, command generation circuit 261 selects a memory table within memory 223 (shown in FIG. 2A). In some embodiments, the memory table is selected by the most significant bits of the transaction identifier (i.e., either transaction identifier 257 or transaction identifier 259). Thus, for example, where the memory is organized into four tables, the two most significant bits of the transaction identifier are used to select one of the four memory tables. In some embodiments, the size of the memory is forty-eight (48) kbits organized into four tables. Based upon the disclosure provided herein, one of ordinary skill in the art will recognize a variety of memory sizes and numbers of tables that may be used in relation to different embodiments.

Network event classification hardware accelerator 200 has a limited memory that is incapable of uniquely storing entries for all possible transaction identifiers. To allow such a space efficient memory, a hash process is used where it is possible for identical or duplicate hash values to be generated from distinct transaction identifiers. Where a duplicate occurs, two or more transaction identifiers will be mapped to the same memory which reduces the accuracy of classifying a network transaction as either a first occurrence of a network traffic event or a subsequent occurrence of a network traffic event. To reduce the occurrence of duplication, the memory is organized into a set of tables where only a subset of the tables is accessed at any given time. It is possible that duplicates may be distributed across multiple tables, and as such the number of tables in the set of tables generally correlates to the impact of any duplication on the accuracy of the classification.

Command generation circuit 261 creates a search command 263. In some embodiments, search command 263 includes three fields: a command type field, a transaction identifier field, and a table field. As an example, the search command may include: a ‘01’ indicating a search, followed by the least significant bits of the transaction identifier (i.e., the bits of the transaction identifier that were not used to select the memory table), followed by the most significant bits of the transaction identifier used to select the memory table as discussed above. The generated search command 263 is provided to a search command queue 269.

Where a search command has been processed and session initiation indicator 233 is a logic ‘0’ indicating that the recently processed search command is the first transaction of a network event, command generation circuit 261 generates an increment command 265 that is stored to an increment command queue 271. The generated increment command is identical to the recently processed search command except that the command type field is changed to indicate an increment command (e.g., ‘11’). In addition, command generation circuit 261 generates a timer based decrement command 267b that is stored to a delayed decrement command queue 273. The generated timer based decrement command is identical to the recently processed search command except that the command type field is changed to indicate a decrement command (e.g., ‘00’).

Where, on the other hand, a search command has been processed and session initiation indicator 233 is a logic ‘1’ indicating that the recently processed search command is not the first transaction of a network event (i.e., is a subsequent transaction of the network event), command generation circuit 261 does not generate a new command. Command generation circuit 261 generates a non-timer based decrement command 267a that is stored to a decrement command queue 281 for a set of memory addresses when a search command corresponding to the set of memory addresses has not been received for a defined period. The generated decrement command is identical to a corresponding search command for the addresses except that the command type field is changed to indicate an increment command (e.g., ‘00’). The decrement command causes the value in each of the addresses to be decremented when the respective value is non-zero.

Delayed decrement command queue 273 retains timer based decrement commands 267b until a timer associated with the respective timer based decrement command 267b expires. In some embodiments, each a timer associated with a respective timer based decrement command 267b when the decrement command is initially stored in delayed decrement command queue 273. The length of the timer is set to be a general approximation of how long a network session spread over a large number of network transactions would be expected to last. As such, when an initial transaction is identified a count is increased, but after a defined time the count will be decreased causing identification of another initial transaction where no other transactions have been logged to the same hashed memory location. In some embodiments, this timer is set to be a general approximation of how the session table can react to this new network transaction. In some embodiments, this timer is fixed at one (1) millisecond. In various embodiments, different network transactions may be associated with different timers. Thus, for example, a media streaming session may have a twenty (20) second timer and an information gathering session may have a one (1) millisecond timer. Based upon the disclosure provided herein, one or ordinary skill in the art will recognize a variety of timer lengths that may be used in relation to different embodiments. In various embodiments, the length of the timer is user programmable.

Where the timer for a respective timer based decrement command in the decrement command queue expires, delayed decrement command queue 273 removes the particular timer based decrement command 273 and stores it as a non-timer based decrement command 279 to decrement command queue 281.

Together, search command queue 269, increment command queue 271, and decrement command queue 281 are referred to as the command queue. The oldest search command in search command queue 269 is provided as a next search command 203; the oldest increment command in increment command queue 271 is provided as a next increment command 205; and the oldest decrement command in decrement command queue 281 is provided as a next increment command 207.

The following pseudocode shows an en-queue operation that may be used in relation to some embodiments:
timer_init: the programmable target latency
timer_remainder_acc: the accumulated remaining time excluding current timer value
   At the event of receiving a decrease request:

```
If (queue length == 0) {
  timer_remainder = 0;
  timer_remainder is pushed into the tail of the queue along with the request data
structure;
  timer_remainder_acc = 0;
  timer starts counting down from timer_init;
} else {
    if (timer_init > ( timer_remainder_acc + the current timer value) ) {
        timer_remainder = timer_init − ( timer_remainder_acc + the current timer
value);
      } else {
        timer_remainder = 0;
      }
  timer_remainder is pushed into the tail of the queue along with the request data
structure;
  timer_remainder_acc = timer_remainder_acc + timer_remainder;
```

The following pseudocode shows a de-queue process corresponding to the preceding en-queue process that may be used in relation to some embodiments:
At the event of the timer expires:

```
  pop out an entry from the head of the decrease queue.
  if (queue_length != 0) {
    new_timer_init = timer_remainder of the new head of the queue;
      if (new_timer_init != 0) {
        timer starts counting down from new_timer_init;
        timer_remainder_acc = timer_remainder_acc − timer_remainder of the new head;
} else {
        timer retires again immediately;
      }
  }
```

At the event queue's storage quota is reached:

```
  pop out an entry from the head of the decrease queue.
  if (queue_length != 0) {
    new_timer_init = the current timer value + timer_remainder of the new head of the
queue;
      if (new_timer_init != 0) {
        timer starts counting down from new_timer_init;
        timer_remainder_acc = timer_remainder_acc − timer_remainder of the new head;
      } else {
        timer retires again immediately;
      }
  }
```

The following pseudocode shows an alternative en-queue process that is simplified to save memory without storing an exact timer remainder. Instead, it has a 1-bit hold flag to indicate if an entry needs to be popped.
timer_init: the programmable target latency
hold_acc: accumulated hold flag in current queue
At the event of receiving a decrease request:

```
If (queue length == 0) {
  Set hold_flag to 0;
  Hold_flag is pushed into the tail of the queue along with the request data structure;
  Hold_acc = 0;
  timer starts counting down from timer_init;
} else {
    if (hold_acc = 0) {
      hold_flag = 1;
      hold_acc = 1;
    }else {
      hold_flag = 0;
    }
  hold_flag is pushed into the tail of the queue along with the request data structure;
}
```

The following pseudocod shows the de-queue operation corresponding to the preceding alternative en-queue operation:
At the event of the timer expires:

```
pop out an entry from the head of the decrease queue.
if (queue_length != 0) {
  flag = hold_flag of the new head of the queue;
  if (flag != 0) {
    timer starts counting down from timer_init;
    hold_acc = 0;
  } else {
    timer retires again immediately;
  }
}
```

At the event queue's storage quota is reached:

```
pop out an entry from the head of the decrease queue.
if (queue_length != 0) {
  flag = hold_flag of the new head of the queue;
    if (flag != 0) {
      timer starts counting down from timer_init;
      hold_acc = 0;
    } else {
      timer retires again immediately;
    }
}
```

Returning to FIG. 2A, next search command 203, next increment command 205, and next increment command 207 are provided to a command scheduler circuit 209 that controls the order in which commands are processed. Where two or more commands are currently stored in the command queue (i.e., the combination of search command queue 269, increment command queue 271, and decrement command queue 281), command scheduler circuit 209 applies a priority algorithm to select which command is selected for processing. In some embodiments, the priority algorithm is a first-in, first-out algorithm where the command (any of next search command 203, next increment command 205, or next increment command 207) that was first stored in the respective one of search command queue 269, increment command queue 271, or decrement command queue 281 is selected.

In other embodiments, command scheduler circuit 209 applies a round-robin, first-in, first-out algorithm where, if a search command was last processed, next increment command 205 if available. If next increment command 205 is not available, next decrement command 207 is selected if available. If next decrement command 207 is not available, next search command 203 is selected if available. Alternatively, if an increment command was last processed, next decrement command 207 is selected if available. If next decrement command 207 is not available, next search command 203 is selected if available. Alternatively, if a decrement command was last processed, next search command 203 is selected if available. If next search command 203 is not available, next increment command 205 is selected if available. If next decrement command 205 is not available, the next decrement command 207 is selected if available.

In yet other embodiments, a priority algorithm is used that prioritizes increment commands over either search or decrement commands. A round-robin, first-in, first-out algorithm is used to select between search and decrement commands. Thus, if one or more increment commands are available in increment command queue 271, next increment command 203 is selected. Alternatively, if increment command queue 269 is empty and a search command was last processed, next decrement command 207 is selected if available. Alternatively, if increment command queue 269 is empty and a decrement command was last processed, next search command 203 is selected if available. Based upon the disclosure provided herein, one of ordinary skill in the art will recognize other priority algorithms that may be used in relation to different embodiments.

Command scheduler circuit 209 provides the memory table selector portion of the selected command (e.g., the most significant bits of the transaction identifier) as a table selection output 211, and provides the remaining portion of the transaction identifier (e.g., the bits of the transaction identifier that were not used to select the memory table) as a table location output 213.

Table selection output 211 is provided to a table selector circuit 215, and based thereon table selector circuit 215 asserts a group of table enable outputs 219 causing a subset of a number of tables 223 of a memory to be enabled while leaving the other tables 223 of the memory disabled. Network event classification hardware accelerator 200 has a limited memory that is incapable of uniquely storing entries for all possible transaction identifiers. In some embodiments, the size of the memory is forty-eight (48) kbits organized into four tables 223. To allow such a space efficient memory, a hash process is used where it is possible for identical or duplicate hash values to be generated from distinct transaction identifiers. Where a duplicate occurs, two or more transaction identifiers will be mapped to the same memory which reduces the accuracy of classifying a network transaction as either a first occurrence of a network traffic event or a subsequent occurrence of a network traffic event. To reduce the occurrence of duplication, the memory is organized into a set of tables where only a subset of the tables is accessed at any given time. It is possible that duplicates may be distributed across multiple tables, and as such the number of tables in the set of tables generally correlates to the impact of any duplication on the accuracy of the classification.

A hash generation circuit 217, hashes table location output 213 with k hash seeds to yield k memory addresses 221 (i.e., memory address 221,0 to memory address 221,k-1). The k memory addresses 221 are designed to access a memory of a size of the selected memory table 223. In some embodiments, each location in the selected memory table 223 holds a three bit value (0-7) that is a counter indicating a number of increment commands applied to the memory location less a number of decrement commands applied (where the value cannot be increased beyond seven (7) or decremented to less than zero (0)). Thus, as a simple example, there the selected memory table is sized as eight (8) kbits, the k memory addresses would be k ten (10) bit addresses. Based upon the disclosure provided herein, one of ordinary skill in the art will recognize other counter sizes and memory space sizes that can be used in relation to different embodiments.

For embodiments discussed herein, k is an integer greater than zero. In general, the larger the value of k, the less duplication of hash values generated for distinct subsets of transaction identifiers, and thus the accuracy of classifying a network transaction as either a first occurrence of a network traffic event or a subsequent occurrence of a network traffic event. In contrast, the greater the value of k, the larger the memory space needed to perform the classification. In some embodiments k is equal to two (2). Based upon the disclosure provided herein, one of ordinary skill in the art will recognize other values of k and corresponding memory sizes that may be used in relation to different embodiments. Further, based upon the disclosure provided herein, one of ordinary skill in the art will recognize a variety of hash seeds that may be used in relation to different embodiments.

Command scheduler circuit 209 provides a command output 235 that corresponds to the selected command. Thus, a combination of memory addresses 221 and table enable outputs 219 select the desired memory table 223 and k locations (i.e., k of M₀ 225, 0-Mₖ₋₁ 225,k-1 for table 223,0 or k of M₀ 227,0-Mₖ₋₁ 227,k-1 for table 223,n), and command output causes a particular action on the k memory locations. In particular, where the selected command is a search command the particular action is to assess the memory locations to generate k memory values (i.e., memory value 229,0 to memory value 229,k-1). Each of memory locations M₀ 225,0-Mₖ₋₁ 225,k-1 is a counter that, as discussed below, is incremented and decremented. In some embodiments, the size of each of memory locations M₀ 225,0−Mₖ₋₁ 225,k-1 is configurable depending upon the size of counters desired. In various embodiments, the size of the of memory locations M₀ 225,0-Mₖ₋₁ 225,k-1 is three (3) bits facilitating a count of 0-7. When the system is started, the values in each of memory locations M₀ 225,0-Mₖ₋₁ 225,k-1 is zero (0).

Alternatively, where command output 235 is an increment command each of the k memory values is incremented where it is less than a defined maximum. The memory values are counters indicating a number of increment commands applied to the memory location less a number of decrement commands applied (where the value cannot be increased beyond a defined maximum or decremented to less than zero (0)). Thus, any of the memory values that are less than the defined maximum is incremented, and any of the memory values that are the defined maximum are left unchanged.

Alternatively, where command output 235 is a decrement command each of the k memory values is decremented where it is greater than zero (0). As such, the memory values in each memory location corresponding to the k memory addresses are respectively decremented. Again, the memory values are counters indicating a number of increment commands applied to the memory location less a number of decrement commands applied (where the value cannot be increased beyond a defined maximum or decremented to less than zero (0)). Thus, any of the memory values that are greater than zero (0) are incremented, and any of the memory values that are zero (0) are left unchanged.

A logical AND circuit 231 logically ANDs k memory values 229 to yield session initiation indicator 233. As such, session initiation indicator 233 is ‘1’ where all of k memory values 229 are greater than zero (0), and session initiation indicator 233 is ‘0’ where any of the k memory values 229 is equal to zero (0). Where session initiation indicator 233 is ‘0’ it is considered to indicate that the recently received transaction from which the search command was generated is the first transaction of a network event. In contrast, where the session initiation indicator is ‘1’ (block 414) it is considered to indicate that the recently received transaction from which the search command was generated is not the first transaction of a network event (i.e., is a subsequent transaction of the network event).

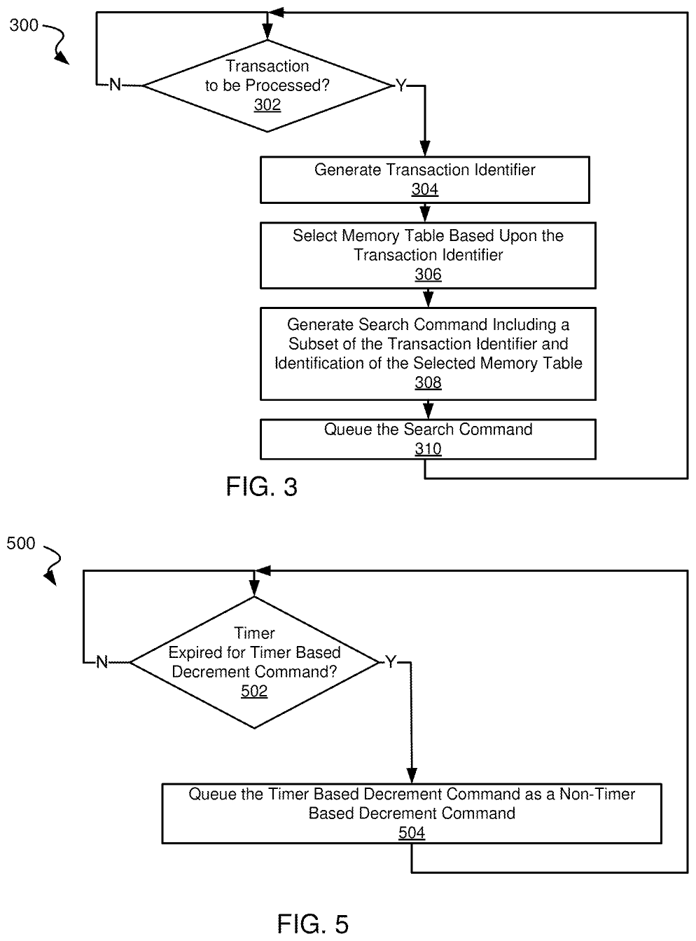

Turning to FIG. 3, a flow diagram 300 shows a method in accordance with some embodiments for generating a search command based upon an identified network event in a network event classification hardware accelerator. Following flow diagram 300, it is determined whether a transaction has been received (block 302). In some embodiments, a transaction is received when a network transmission is received. Such a network transmission may be any data transfer from one network device to another network device. Such network transactions include, for example, identifying information that may be included in a header and data to be transferred. The network transactions may or may not be encoded or encrypted. The identifying information may include, but is not limited to, a source IP address, a destination IP address, a layer four protocol, a source port, and/or a destination port. Based upon the disclosure provided herein, one of ordinary skill in the art will recognize a variety of network transactions that may be processed in accordance with different embodiments. Further, based upon the disclosure provided herein, one of ordinary skill in the art will recognize a variety of identification information that may be included in the network transaction.

A transaction identifier is generated using all of part of the identification information received as part of the network transaction (block 304). In some embodiments, the transaction identifier is a combination of two or more elements of the identification information that when combined allow for a network transaction to be identified. As more of the identification information is included in the transaction identifier, the transaction identifier becomes more likely to uniquely identify the network transaction being identified. In various embodiments, the transaction identifier is generated by concatenating the source IP address, the destination IP address, the source port, and the destination port. Based upon the disclosure provided herein, one of ordinary skill in the art will recognize a variety of data combinations that may be used to create a transaction identifier in accordance with different embodiments.

A memory table is selected based upon the transaction identifier (block 306). In some embodiments, the memory table is selected by the most significant bits of the transaction identifier. Thus, for example, where the memory is organized into four tables, the two most significant bits of the transaction identifier are used to select one of the four memory tables. In some embodiments, the size of the memory is forty-eight (48) kbits organized into four tables. Based upon the disclosure provided herein, one of ordinary skill in the art will recognize a variety of memory sizes and numbers of tables that may be used in relation to different embodiments.

As discussed above, the network event classification hardware accelerator has a limited memory that is incapable of uniquely storing entries for all possible transaction identifiers. To allow such a space efficient memory, a hash process is used where it is possible for identical or duplicate hash values to be generated from distinct transaction identifiers. Where a duplicate occurs, two or more transaction identifiers will be mapped to the same memory which reduces the accuracy of classifying a network transaction as either a first occurrence of a network traffic event or a subsequent occurrence of a network traffic event. To reduce the occurrence of duplication, the memory is organized into a set of tables where only one subset of the tables is accessed at any given time. It is possible that duplicates may be distributed across multiple tables, and as such the number of tables in the set of tables generally correlates to the impact of any duplication on the accuracy of the classification.

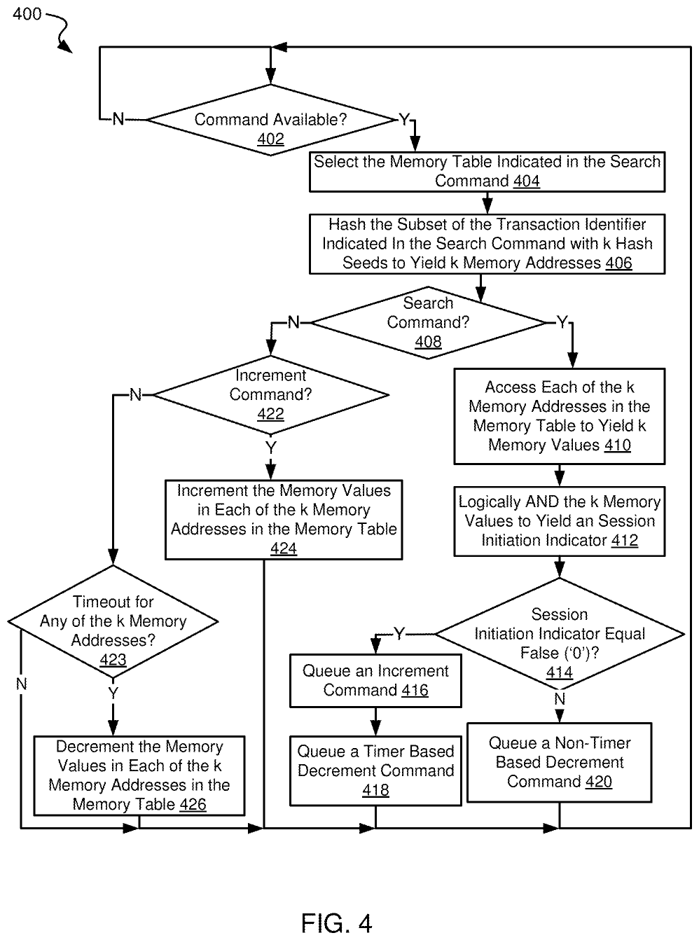

A search command is generated that includes a subset of the transaction identifier and the identification of the selected memory table (block 308). In some embodiments, the search command includes three fields: a command type field, a transaction identifier field, and a table field. As an example, the search command may include: a ‘01’ indicating a search, followed by the least significant bits of the transaction identifier (i.e., the bits of the transaction identifier that were not used to select the memory table), followed by the most significant bits of the transaction identifier used to select the memory table as discussed above. The generated search command is stored to a command queue of the network event classification hardware accelerator (block 310). The queued command will in time be selected for processing by a scheduler of the network event classification hardware accelerator as more fully discussed below in relation to FIG. 4.

Turning to FIG. 4, a flow diagram 400 shows a method in accordance with some embodiments processing network events in a network event classification hardware accelerator. Following flow diagram 400, it is determined whether a command has been queued (block 402). A command is determined to be queued whenever one or more commands are stored in a command queue of the network event classification hardware accelerator. Where two or more commands are currently stored in the command queue a priority algorithm is employed to select the next command to process. In some embodiments, the priority algorithm is a first-in, first-out algorithm where the command that was stored first is selected for processing.

In other embodiments the commands are organized in the command queue according to their type (search, increment, decrement), and a round-robin, first-in, first-out algorithm is used where, if a search command was last processed, the oldest increment command is selected if available. If an increment command is not available, the oldest decrement command is selected if available. If a decrement command is not available, the oldest search command is selected if available. Alternatively, if an increment command was last processed, the oldest decrement command is selected if available. If a decrement command is not available, the oldest search command is selected if available. If a search command is not available, the oldest increment command is selected if available. Alternatively, if a decrement command was last processed, the oldest search command is selected if available. If a search command is not available, the oldest increment command is selected if available. If an increment command is not available, the oldest decrement command is selected if available.

In yet other embodiments the commands are organized in the command queue according to their type (search, increment, decrement), and a priority algorithm is used that prioritizes increment commands over either search or decrement commands. A round-robin, first-in, first-out algorithm is used to select between search and decrement commands. Thus, if one or more increment commands are available, the oldest increment command is selected. Alternatively, if an increment command is not available and a search command was last processed, the oldest decrement command is selected if available. Alternatively, if an increment command is not available and a decrement command was last processed, the oldest search command is selected if available. Based upon the disclosure provided herein, one of ordinary skill in the art will recognize other priority algorithms that may be used in relation to different embodiments.

Once the command has been accessed from the command queue (and removed from the command queue (block 402), the memory table indicated in the command is selected (block 404). In some embodiments, selecting the memory table causes the outputs of the selected memory to be enabled while the outputs of all other memory tables are disabled. In addition, subset of the transaction identifier included in the command is hashed with k hash seeds to yield k memory addresses (block 406). The k memory addresses are designed to access a memory of a size of the selected memory table. In some embodiments, each location in the selected memory table holds a three bit value (0-7) that is a counter indicating a number of increment commands applied to the memory location less a number of decrement commands applied (where the value cannot be increased beyond seven (7) or decremented to less than zero (0)). Thus, as a simple example, there the selected memory table is sized as eight (8) kbits, the k memory addresses would be k ten (10) bit addresses. Based upon the disclosure provided herein, one of ordinary skill in the art will recognize other counter sizes and memory space sizes that can be used in relation to different embodiments.

For embodiments discussed herein, k is an integer greater than zero. In general, the larger the value of k, the less duplication of hash values generated for distinct subsets of transaction identifiers, and thus the accuracy of classifying a network transaction as either a first occurrence of a network traffic event or a subsequent occurrence of a network traffic event. In contrast, the greater the value of k, the larger the memory space needed to perform the classification. In some embodiments k is equal to two (2). Based upon the disclosure provided herein, one of ordinary skill in the art will recognize other values of k and corresponding memory sizes that may be used in relation to different embodiments. Further, based upon the disclosure provided herein, one of ordinary skill in the art will recognize a variety of hash seeds that may be used in relation to different embodiments.

It is determined whether the command is a search command (block 408). This is determined by querying the command type field of the command. Where the command is a search command (block 408), each memory location corresponding to the k memory addresses are accessed in the selected memory table to yield k memory values (block 410). As mentioned before, the memory values are counters indicating a number of increment commands applied to the memory location less a number of decrement commands applied (where the value cannot be increased beyond a defined maximum or decremented to less than zero (0)). Thus, the memory access results in k counter values each between zero (0) and a defined maximum.

The k memory values are all logically ANDed to yield a session initiation indicator (block 412). As such, the session initiation indicator output is ‘1’ where all of the k memory values are greater than zero (0), and the session initiation indicator is ‘0’ where any of the k memory values is equal to zero (0). Where the session initiation indicator is ‘0’ (block 414) it is considered to indicate that the recently received transaction from which the search command was generated (see FIG. 3) is the first transaction of a network event. In contrast, where the session initiation indicator is ‘1’ (block 414) it is considered to indicate that the recently received transaction from which the search command was generated (see FIG. 3) is not the first transaction of a network event (i.e., is a subsequent transaction of the network event).

Where the session initiation indicator is ‘0’ (block 414), an increment command is stored to the command queue (block 416). The increment command is identical to the recently processed search command except that the command type field is changed to indicate an increment command. In addition, a timer based decrement command is queued to a delayed decrement command queue (block 418). The timer based decrement command is identical to the recently processed search command except that the command type field is changed to indicate a decrement command. As discussed below in relation to FIG. 5, this timer based decrement command remains in the delayed decrement command queue until a timer expires at which time it is moved to the command queue where it is processed as decrement command.

Alternatively, where the session initiation indicator is ‘1’ (block 414), a non-timer based decrement command is stored to the command queue (block 420). A non-timer based decrement command is identical to the previously described timer based decrement command, except that it is stored directly to the command queue without first being timed through the delayed decrement command queue.

Where it is determined whether the command is not a search command (block 408), it is determined whether it is an increment command (block 422). This is determined by querying the command type field of the command. Where the command is an increment command (block 422), the memory values in each memory location corresponding to the k memory addresses are respectively incremented (block 424). As mentioned before, the memory values are counters indicating a number of increment commands applied to the memory location less a number of decrement commands applied (where the value cannot be increased beyond a defined maximum or decremented to less than zero (0)). Thus, any of the memory values that are less than the defined maximum is incremented, and any of the memory values that are the defined maximum are left unchanged.

Where it is determined whether the command is not an increment command (block 422), the possibility of a decrement command is considered. In particular, it is determined whether a defined time period has expired since a search command corresponding to any of the k memory addresses has been processed (block 423). In some embodiments, the time period is one (1) millisecond. In various cases, the time period is user programmable. Where the time period has expired (block 423), the memory values in each memory location corresponding to the k memory addresses are respectively decremented (block 426). As mentioned before, the memory values are counters indicating a number of increment commands applied to the memory location less a number of decrement commands applied (where the value cannot be increased beyond a defined maximum or decremented to less than zero (0)). Thus, any of the memory values that are greater than zero (0) are incremented, and any of the memory values that are zero (0) are left unchanged.

Turning to FIG. 5, a flow diagram 500 shows a method in accordance with some embodiments processing time based clearing in a network event classification hardware accelerator. Following flow diagram 500, it is determined whether a timer has expired for a timer based decrement command stored in the decrement command queue (block 502). In some embodiments, each a timer is started when a timer based decrement command is initially stored in the decrement command queue. The length of the timer is set to be a general approximation of how long a network session spread over a large number of network transactions would be expected to last. As such, when an initial transaction is identified (see FIG. 4) a count is increased, but after a defined time the count will be decreased causing identification of another initial transaction where no other transactions have been logged to the same hashed memory location. In some embodiments, this timer is fixed at one (1) millisecond. Based upon the disclosure provided herein, one or ordinary skill in the art will recognize a variety of timer lengths that may be used in relation to different embodiments. In various embodiments, the length of the timer is user programmable.

Where the timer for a respective timer based decrement command in the decrement command queue expires (block 502), the particular timer based decrement command is stored to the command queue as a non-timer based decrement command (block 504). At this point the decrement command will await selection according to the priority algorithm and processing as discussed above in relation to FIG. 4.

In conclusion, the present invention provides for novel systems, devices, and methods. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for classifying network events into the first occurrence of the event and the subsequent occurrence of the same event, the method comprising:
receiving, by a network event classification circuit, a network event;
generating, by the network event classification circuit, a transaction identifier identifying the network event;
generating, by the network classification circuit, a search command including a subset of the transaction identifier; and
executing, by the network classification circuit, the search command, wherein executing the search command includes:
hashing the subset of the transaction identifier with a first hash seed to yield a first memory address, and hashing the subset of the transaction identifier with a second hash seed to yield a second memory address; and
generating a classification of the network event based at least in part upon a first value accessed from a memory at the first memory address and a second value accessed from the memory at the second memory address.

2. The method of claim 1, the method further comprising:
performing, by a processing resource, a network process using at least the classification of the network event.

3. The method of claim 2, wherein the network process is selected from a group consisting of: a denial of service attack detection process, and a network transaction logging process.

4. The method of claim 1, wherein the memory is organized into a plurality of tables, wherein the subset of the transaction identifier is a first subset of the transaction identifier, and wherein the method further comprises:
enabling, by the network classification circuit, a memory table of the plurality of tables, wherein the memory table is selected based at least in part on a second subset of the transaction identifier.

5. The method of claim 1, wherein the classification of the network event indicates an initial occurrence, the method further comprising:
executing, by the network classification circuit, an increment command, wherein executing the increment command includes:
incrementing the first value at the first memory address and incrementing the second value at the second memory address.

6. The method of claim 5, the method further comprising:
when a search command corresponding to either the first memory address or the second memory address has not been received for a defined period, executing, by the network classification circuit, a decrement command, wherein executing the decrement command includes:
decrementing the first value at the first memory address and the second value at the second memory address.

7. The method of claim 6, wherein the defined period is user programmable.

8. The method of claim 5 the method further comprising:
as part of the executing the increment command, queuing, by the network classification circuit, a decrement command.

9. The method of claim 8, the method further comprising:
determining, by the network classification circuit, a time expiration of the decrement command; and
based at least in part on the time expiration, executing, by the network classification circuit, the decrement command, wherein executing the decrement command includes:
decrementing the first value at the first memory address and the second value at the second memory address.

10. The method of claim 1, wherein generating the classification of the network event based at least in part upon a first value accessed from a memory at the first memory address and a second value accessed from the memory at the second memory address includes:
determining that both the first value and the second value are zero; and
indicating that the classification of the network event indicates an initial 6 occurrence based at least in part on the determination that both the first value and the second value are zero.

11. The method of claim 1, wherein generating the classification of the network event based at least in part upon a first value accessed from a memory at the first memory address and a second value accessed from the memory at the second memory address includes:
determining that at least one of the first value and the second value is greater than zero; and
indicating that the classification of the network event indicates a subsequent occurrence based at least in part on the determination that at least one of first value and the second value is greater than zero.

12. The method of claim 1, wherein the search command is stored in a search command queue, the increment command is stored in an increment command queue, and the decrement command is stored to a decrement command queue.

13. The method of claim 12, wherein accessing a command by the network classification circuit from one of the search command queue, the increment command queue, or the decrement command is based upon a priority algorithm, and wherein the priority algorithm causes all commands in the increment command queue to be executed before any command in either the search command queue or the decrement command queue.

14. The method of claim 1, wherein the network event is a network packet.

15. A network event classification device, the device comprising:
a network interface circuit configured to receive a network event;
a network processor configured to:
generate a transaction identifier identifying the network event;
generate a search command including a subset of the transaction identifier; and
execute the search command, wherein executing the search command includes:
hashing the subset of the transaction identifier with a first hash seed to yield a first memory address, and hashing the subset of the transaction identifier with a second hash seed to yield a second memory address; and
generating a classification of the network event based at least in part upon a first value accessed from a memory at the first memory address and a second value accessed from the memory at the second memory address.

16. The device of claim 15, wherein the device is implemented as a network interface card, and wherein the network interface card includes a first general purpose processor configured to interface with a second general purpose processor of a network security appliance.

17. The device of claim 16, wherein the second general purpose processor is communicably coupled to a non-transitory computer readable medium having stored therein instructions which when executed by the second general purpose processor causes the second general purpose processor to:
perform a network process using at least the classification of the network event, and wherein the network process is selected from a group consisting of: a denial of service attack detection process, and a network transaction logging process.

18. The device of claim 15, wherein the device is imbedded into a network security appliance, and where the network processor is coupled to a general purpose processor of the network security appliance.

19. The device of claim 18, wherein the general purpose processor is communicably coupled to a non-transitory computer readable medium having stored therein instructions which when executed by the general purpose processor causes the general purpose processor to:
perform a network process using at least the classification of the network event, and wherein the network process is selected from a group consisting of: a denial of service attack detection process, and a network transaction logging process.

20. The device of claim 1, wherein the classification of the network event indicates an initial occurrence, and wherein the network processor is further configured to:
execute an increment command, wherein executing the increment command includes:
incrementing the first value at the first memory address and incrementing the second value at the second memory address.
